(19) United States
(12) Patent Application Publication
(10) Pub. No.: US 2009/0291414 A1
(43) Pub. Date: Nov. 26, 2009

(54) METHOD FOR FORMING A DENTAL IMPLANT

(75) Inventor: Chan Qian Wang, Beachwood, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Bioinfera, Inc.

(21) Appl. No.: 12/126,044

(22) Filed: May 23, 2008

(51) Int. Cl. A61C 8/00

(52) U.S. Cl. 433/174

(57) ABSTRACT

A method for forming a dental implant includes drilling a pilot hole in the jaw bone of a subject and then threading an implant body into the pilot hole. The implant body includes a threaded portion integrally formed with a head portion having a polygonal recess. The implant body is threaded until the threaded portion reaches a predetermined seating depth. Next, an impression coping is mated with the polygonal recess of the implant body so that a portion of the impression coping is friction fit within the polygonal recess. After mating the impression coping with the implant body, an impression of the impression coping is formed. An implant analog is then mated with a portion of the impression coping without dissecting a portion of the impression tray. The implant analog is then used to form the dental implant.

### TECHNICAL FIELD

The present invention relates generally to a method for forming a dental implant, and more particularly to a non-open tray method for forming a dental implant.

### BACKGROUND OF THE INVENTION

Dental implant systems are widely used for replacing damaged or lost natural teeth. In such systems, an implant is placed in the jaw of a patient to replace the natural tooth root. An abutment comprising one or several parts may then be attached to the implant to build up a core for the part of a prosthetic tooth protruding from the bone tissue, through the soft gingival tissue, and into the mouth of the patient. On the abutment, a prosthesis or crown may finally be seated.

Present methods for forming dental implants require the procedure to be performed by a dental specialist, such as an oral surgeon or periodontist. A general dentist, however, must refer patients in need of dental implants to one of these specialists. For the referring dentist, this represents a loss in potential income as the dentist is unable able to perform the procedure. For this reason, as well as the time-consuming and labor-intensive process for forming dental implants, only a small portion of general dentists offer dental implants to their patients.

### SUMMARY OF THE INVENTION

According to one aspect of the present invention, a method is provided for forming a dental implant. One step of the method includes drilling a pilot hole in the jaw bone of a subject and then threading an implant body into the pilot hole. The implant body comprises a threaded portion integrally formed with a head portion having a polygonal recess. The implant body is threaded until the threaded portion reaches a predetermined seating depth. Next, an impression coping is mated with the polygonal recess of the implant body so that a portion of the impression coping is friction fit within the polygonal recess. After mating the impression coping with the implant body, an impression of the impression coping is formed. An implant analog is then mated with a portion of the impression coping without dissecting a portion of the impression tray. The implant analog is then used to form the dental implant.

According to another aspect of the present invention, a method is provided for forming a dental implant. One step of the method includes drilling a pilot hole in the jaw bone of a subject and then threading an implant body into the pilot hole. The implant body comprises a threaded portion integrally formed with a head portion having a polygonal recess. The implant body is threaded until the threaded portion reaches a predetermined seating depth. Next, a portion of an impression coping is screwed into the inner receptacle portion of the implant body. After mating the impression coping with the implant body, an impression of the impression coping is formed. An implant analog is then mated with a portion of the impression coping without dissecting a portion of the impression tray. The implant analog is then used to form the dental implant.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a process flow diagram illustrating a method for forming a dental implant in accordance with one aspect of the present invention;

FIG. 2A is a perspective view showing application of a tissue punch to a portion of a gingival surface;

FIG. 2B is a perspective view showing removal of a gingival tissue plug using the tissue punch in FIG. 2A;

FIG. 3A is a perspective view of a pilot drill bit;

FIG. 3B is a perspective view showing the pilot drill bit of FIG. 3A being used to drill a pilot hole into a jaw bone;

FIG. 3C is a perspective view showing a guide pin inserted into the pilot hole in FIG. 3B;

FIG. 4A is a perspective view showing an implant body;

FIG. 4B is a perspective view showing a torque tool;

FIG. 4C is a perspective view showing a torque abutment;

FIG. 4D is a perspective view showing the torque tool (FIG. 4B) and the torque abutment (FIG. 4C) being used to screw the implant body (FIG. 4A) into the jaw bone;

FIG. 4E is a perspective view showing the implant body (FIG. 4A) implanted in the jaw bone;

FIG. 5A is a perspective view of an impression coping;

FIG. 5B is a perspective view showing the impression coping in FIG. 5A mated with the implant body of FIG. 4E;

FIG. 6A is a perspective view showing an impression tray filled with an impression material seated on the impression coping in FIG. 5B;

FIG. 6B is a perspective view showing an implant analog mated with the impression coping (FIG. 5A);

FIG. 6C is a perspective view of the implant analog shown in FIG. 6B;

FIG. 6D is a cross-sectional view of the implant analog shown in FIG. 6C;

FIG. 7A is a perspective view showing the impression tray in FIG. 6B mated with a cast molding;

FIG. 7B is a perspective view showing the implant analog in FIG. 7A secured in the cast molding;

FIG. 7C is a perspective view showing a final restoration mated with the implant analog in FIG. 7B;

FIG. 8 is a process flow diagram illustrating a method for forming a dental implant according to another aspect of the present invention;

FIG. 9A is a perspective view showing an alternative embodiment of the impression coping in FIG. 5A;

FIG. 9B is a cross-sectional view of the impression coping shown in FIG. 9A;

FIG. 9C is a perspective view showing the impression coping of FIGS. 9A-B being screwed into the implant body in FIG. 4A;

FIG. 9D is a perspective view showing the impression coping in FIG. 9C mated with the implant body of FIG. 9C;

FIG. 10A is a perspective view showing an impression tray filled with an impression material being mated with the impression coping in FIG. 9D;

FIG. 10B is a top plan view showing an inverse impression left by the impression coping (FIG. 9A) in the impression material;

FIG. 11A is a perspective view showing an implant analog being mated with the impression coping in FIG. 10A; and

FIG. 11B is a perspective view of a cast molding showing the impression coping (FIG. 9A) being removed from the implant analog (FIG. 11A).

### DETAILED DESCRIPTION

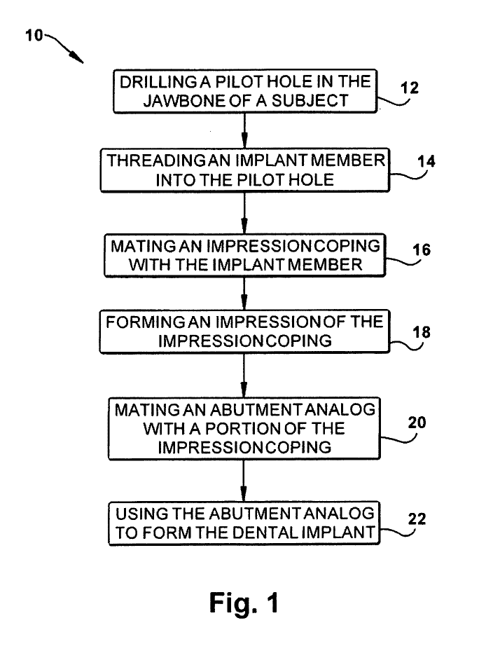

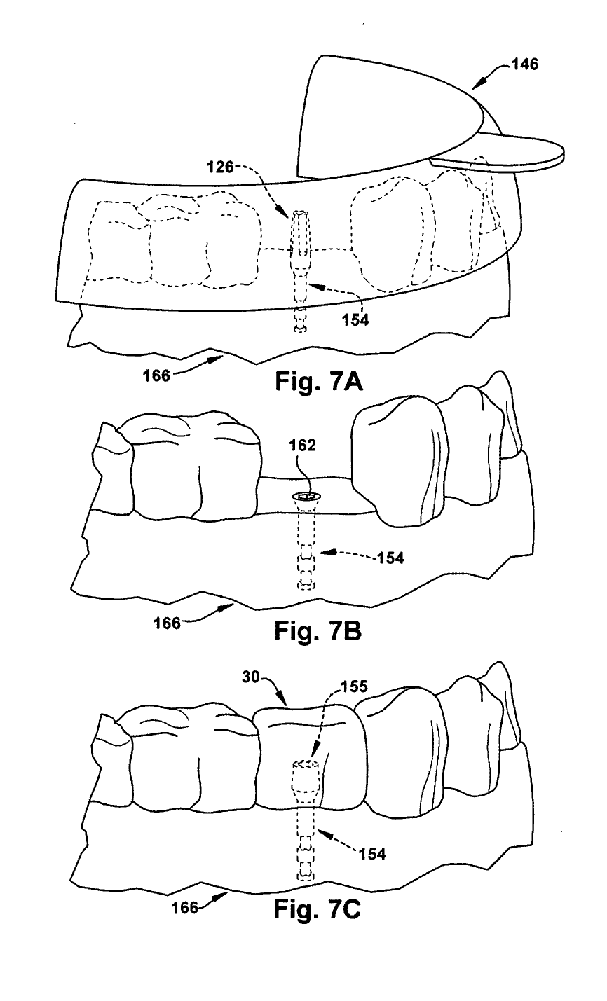

The present invention relates generally to a method for forming a dental implant, and more particularly to a non-open tray method for forming a dental implant. As representative of the present invention, FIG. 1 illustrates a method 10 for forming a dental implant 30 (FIG. 7C). The present invention provides the general dentist with a simple and cost-effective approach to forming dental implants 30, without the need for referral to a dental specialist. By combining improved dental components with a non-open tray approach, the present invention provides general dentists with a simplified, one-step approach for forming dental implants 30.

Unless otherwise defined, all technical terms used herein have the same meaning as commonly understood by one of ordinary skill in the art to which the present invention pertains.

In the context of the present invention, the term “dental implant” refers to an artificial tooth root replacement used in prosthetic dentistry to support restorations that resemble a tooth or group of teeth.

FIG. 1 is process flow diagram illustrating an aspect of the present invention. In FIG. 1, a method 10 is provided for forming a dental implant 30 (FIG. 7C). At 12, one step of the method 10 (FIG. 1) includes drilling a pilot hole 32 in the jaw bone 34 of a subject. Although the term “subject” as used herein typically refers to a human subject, it will be appreciated that the term can also include any warm-blooded organism including, but not limited to, pigs, rats, mice, dogs, goats, sheep, horses, monkeys, apes, rabbits, cattle, etc. The present invention is useful for replacing lost or damaged teeth as a result of trauma or disease, for example.

Prior to drilling the pilot hole 34, a surgical site 36 comprising a portion of the subject's jaw bone 34 in need of a dental implant 30 is first measured to determine the appropriate size of the dental implant. For example, a measuring device (not shown) is used to determine the width and depth of the surgical site 36. The measuring device can be used in combination with radiological devices, such as X-ray and CT machines to determine the dimensions of the surgical site 36. Measuring devices and related methods for determining the dimensions of the surgical site 36 are well known in the art.

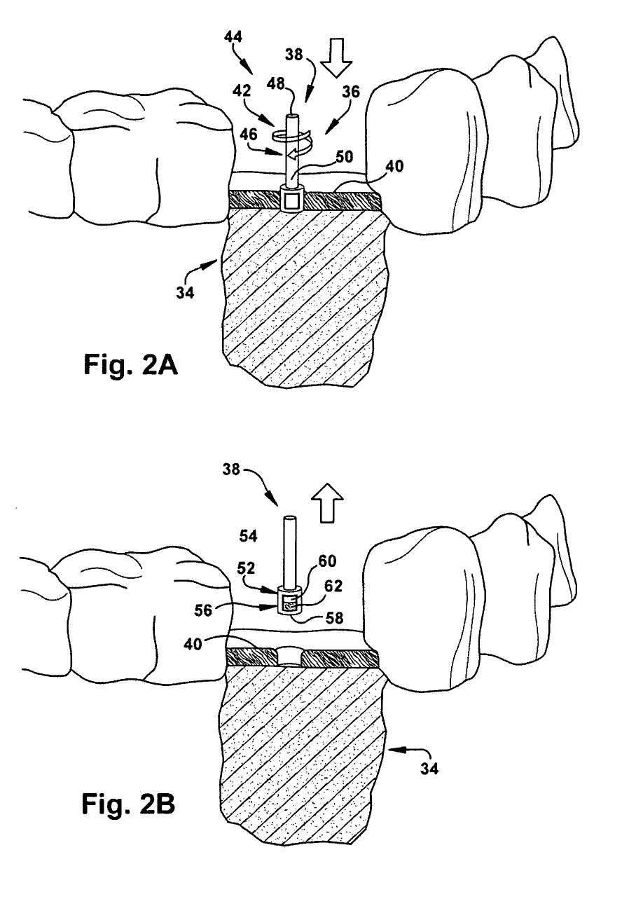

After determining the dimensions of the surgical site 36, a tissue punch 38 (FIG. 2A) is used to puncture a gingival surface 40 of the surgical site 36. As shown in FIGS. 2A-B, the tissue punch 38 comprises an elongated main body portion 42 having first and second end portions 44 and 46. The first end portion 44 has a thin, tube-like configuration with first and second ends 48 and 50. The first end 48 of the first end portion 44 is adapted for attachment to a dental drill (not shown) or blunt dissection tool (not shown). The second end 50 is integrally formed with the second end portion 46 of the tissue punch 38.

The second end portion 46 of the tissue punch 38 has a cylindrical configuration and includes a center portion 52 (FIG. 2B) having first and second ends 54 and 56. The first end 54 is integrally formed with the second end 50 of the first end portion 44, and the second end 56 includes a cutting surface 58 for penetrating tissue. The center portion 52 includes an aperture 60 extending therethrough to facilitate removal of a gingival tissue plug 62 during and after operation of the tissue punch 38. The gingival tissue plug 62 can be removed from the center portion 52 using a high speed drill (not shown) or a pair of tweezers (not shown), for example.

Using a dental drill, for example, the tissue punch 38 is caused to spin (indicated by the curved arrow) at a desired speed (FIG. 2A). The tissue punch 38 is then moved into contact with the gingival surface 40 so that the second end 56 of the second end portion 46 punctures the gingival tissue. Pressure is applied to the dental drill so that the tissue punch 38 penetrates the gingival tissue and contacts the surface 64 of the jaw bone 34. When the second end 56 of the second end portion 46 contacts the surface 64 of the jaw bone 34, the dental drill is slowly pulled away so that the tissue punch 38 is withdrawn from the subject's mouth and a portion of the jaw bone is exposed (FIG. 2B). As shown in FIG. 2B, the gingival tissue plug 62 removed by the tissue punch 38 is consequently disposed in the center portion 52 of the tissue punch.

Use of the tissue punch 38 to expose a portion of the jaw bone 34 has several advantages over prior art methods, which use a scalpel or other similar means to create a flap of gingival tissue. Creation of a gingival flap is a multi-step, time-consuming process that can take around 30 to 35 minutes. The tissue punch 38 of the present invention allows for a one-step process in which gingival tissue is easily cut to create smooth edges and thereby reduce or eliminate the need for subsequent gum surgery. Flapless surgery simplifies the dental implant procedure, reduces surgical trauma, eliminates re-opening of the surgical site, reduces potential infection, and promotes shorter healing time.

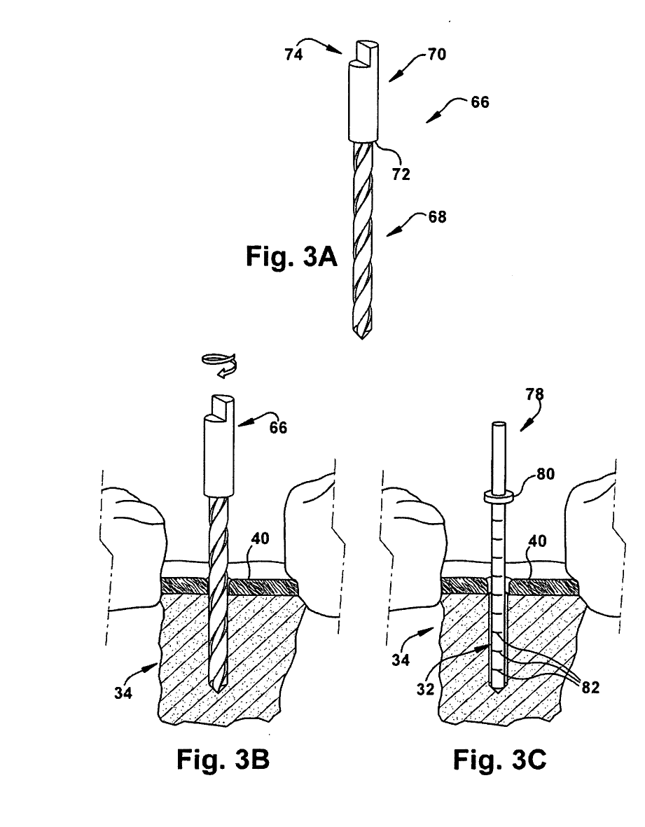

After exposing the subject's jaw bone 34, a pilot drill bit 66 (FIG. 3A) is used to drill a pilot hole 32 in the jaw bone at 12. As shown in FIG. 3A, the pilot drill bit 66 comprises a threaded portion 68 integrally formed with a main body portion 70. The main body portion 70 includes a shoulder end 72 and an attachment end 74 for attaching the pilot drill bit 66 to a dental drill (not shown). The diameter of the threaded portion 68 is less than the diameter of the shoulder end 72. The greater diameter of the shoulder end 72 (as compared to the diameter of the threaded portion 68) ensures that the pilot drill bit 66 only penetrates the jaw bone 34 to a depth equal to the length of the threaded portion.

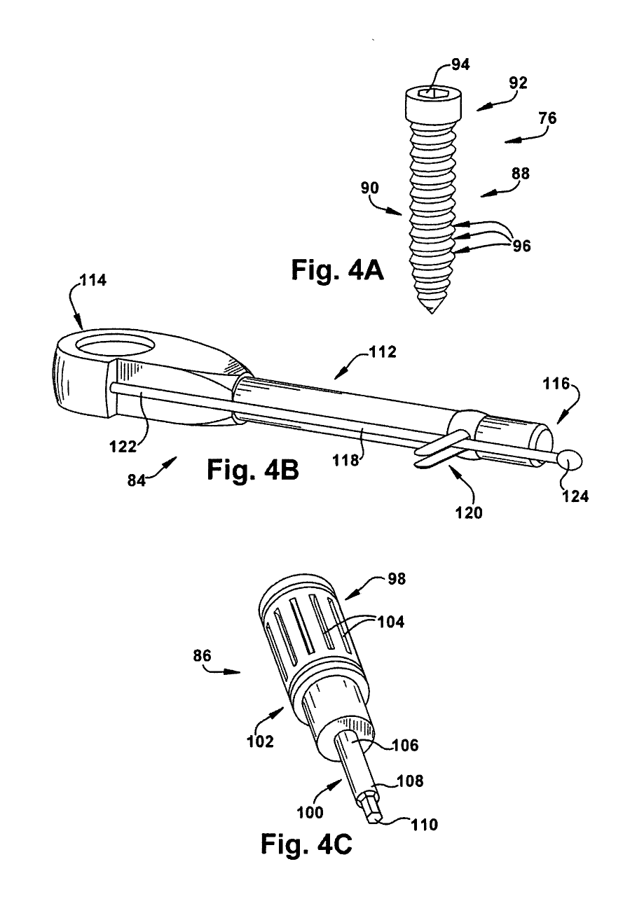

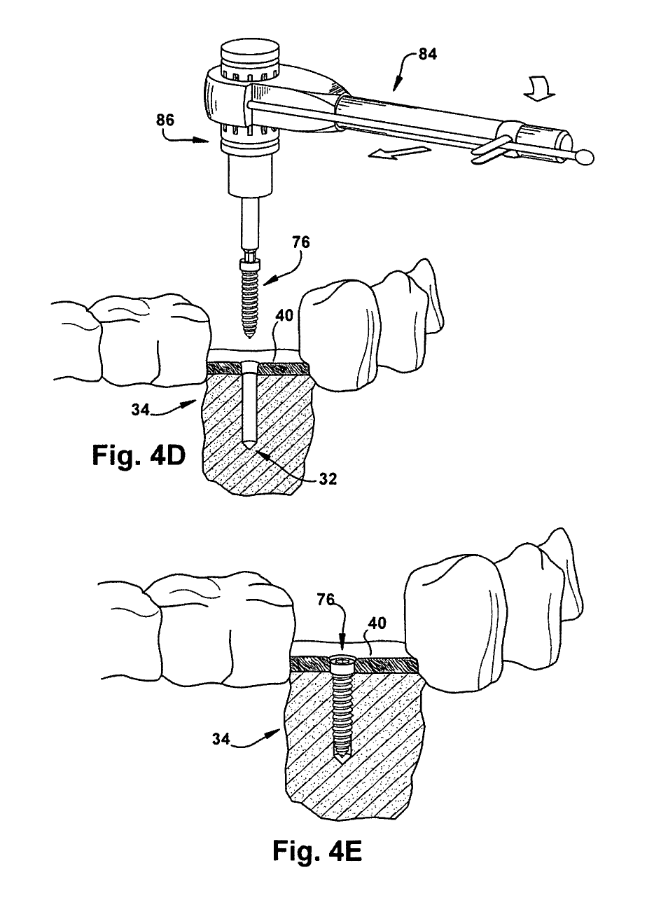

The length and diameter of the pilot drill bit 66 is selected based on the measured dimensions of the subject's jaw bone 34 and the size of the dental implant 30 needed. For example, a pilot drill bit 66 having a diameter substantially equal to the diameter of an implant body 76 (FIG. 4A) is selected. A dental drill is used to drill the pilot drill bit 66 into the jaw bone 34 of the subject (FIG. 3B). The pilot drill bit 66 is advanced until the shoulder end 72 penetrates the jaw bone 34 to a predetermined seating depth that is equal to the length of the threaded portion 68.

After forming the pilot hole 32, an expanding drill bit (not shown) is used to thread the pilot hole and modify the pilot hole to a desired width and depth. Next, a guide pin 78 (FIG. 3C) is inserted into the pilot hole to assess the geometry of the pilot hole. As shown in FIG. 3C, the guide pin 78 has an elongated, needle-like configuration. The guide pin 78 has a shoulder 80 to stop the guide pin at a predetermined depth in the pilot hole 32. The guide pin 78 also includes a plurality of spaced-apart indicator markings 82. The indicator markings 82 are used to assess the depth of the pilot hole 32. As shown in FIG. 3C, the predetermined seating depth can be verified by inserting the guide pin 78 into the pilot hole 32 and then noting the corresponding indicator marking 82 at the surface 64 of the jaw bone 34. If the alignment of the guide pin 78 is not acceptable, the pilot hole 32 can be realigned, re-drilled, and/or checked again. For example, if the pilot hole 32 is too shallow, the pilot drill bit 66 can be used to increase the depth of the pilot hole. Alternatively, if the pilot hole 32 is too deep, a composition (e.g., bone cement) can be filled into the pilot hole until the pilot hole obtains the predetermined seating depth.

Depending upon the location of the surgical site 36, a tap drill bit (not shown) can next be used to increase the depth of the pilot hole 32. The thickness of cortical bone in the lower jaw bone 34 is greater than the thickness of cortical bone in the upper jaw bone (not shown). Therefore, where the surgical site 36 comprises a portion of the upper jaw bone, use of a tap drill bit may not be needed to increase the depth of the pilot hole 32. Rather, the implant body 76 (FIG. 4A) can be manually threaded into the thinner layer of cortical bone to facilitate formation of a tight bond between the implant body and the bone. Conversely, where the surgical site 36 comprises a lower portion of the jaw bone 34, a tap drill bit may be needed to penetrate into the thicker cortical bone layer and thereby provide an accessible substrate for the implant body 76.

At 14, the implant body 76 is threaded into the pilot hole 32 using a torque tool 84 (FIG. 4B) and a torque abutment 86 (FIG. 4C). As shown in FIG. 4A, the implant body 76 comprises a body member 88 having a threaded portion 90 integrally formed with a head portion 92. The head portion 92 includes a polygonal recess 94. In FIG. 4A, the polygonal recess 94 is hex-shaped; however, it will be appreciated that the polygonal recess can have any other desired shape, such as a square or rounded shape. The threaded portion 90 also includes a plurality of spaced-apart threads 96. The threads 96 are spaced apart at a substantially equal distance and have a rounded configuration. The rounded configuration of the threads 96 facilitates implantation and osteointegration of the implant body 76. The implant body 76 can be made of any one or combination of biocompatible materials known in the art, such as titanium or a titanium alloy.

To thread the implant body 76 into the pilot hole 32, the implant body is first positioned adjacent the pilot hole (FIG. 4D). As shown in FIG. 4D, the torque abutment 86 is then mated with the polygonal recess 94 of the implant body 76. The torque abutment 86 (FIG. 4C) comprises first and second end portions 98 and 100 and a center body portion 102 extending between the end portions. The first end portion 98 has a cylindrical shape and includes a plurality of fenestrations 104. As described in more detail below, the fenestrations 104 facilitate interlocking of the torque tool 84 with the torque abutment 86. The center body portion 102 has a cylindrical shape and is integrally formed with the first and second end portions 98 and 100. The second end portion 100 has an elongated, cylindrical configuration and includes first and second ends 106 and 108. The first end 106 is integrally formed with the center body portion 102, and the second end 108 includes a polygonal-shaped male member 110 for mating with the polygonal recess 94 of the implant body 76. As shown in FIG. 4C, the polygonal-shaped male member 110 is hex-shaped; however, it will be appreciated that the polygonal-shaped male member can have any other desired shape.

After mating the polygonal-shaped male member 110 with the polygonal recess 94 of the implant body 76, the torque tool 84 is mated with the first end portion 98 of the torque abutment 86 as shown in FIG. 4D. The torque tool 84 comprises an elongated body member 112 having a first end portion 114 and a second end portion 1 16. The torque tool 84 also includes a torque indicator rod 118 extending parallel to the elongated body member 112. The first end portion 114 has a closed wrench configuration for mating with the torque abutment 86. The second end portion 116 includes a torque indicator 120 which extends perpendicular to the elongated body member 112. The torque indicator rod 118 includes a first end 122 operably connected with the first end portion 114, and a second end 124 that is slidably connected to the torque indicator 120.

At 14, the torque tool 84 is rotated (as indicated by the directional arrows) so that a rotational force is transmitted through the torque abutment 86 and into the implant body 76 (FIG. 4D). The torque tool 84 is rotated until the implant body 76 reaches the predetermined seating depth (FIG. 4E). Any additional number of full or partial turns is then made with the torque tool 84 until a torque of approximately 30-70 N/cm is indicated by the torque indicator rod 118. At this point, the threaded portion 90 of the implant body 76 slightly condenses the bone at the tip of the implant body and pulls up on the surrounding bone tissue. The depth of the implant body 76 is established so that a portion of the head portion 92 is wedged into the outer cortical layer of bone. The rest of the head portion 92 penetrates through the pilot hole 32 in the gingival tissue so that the head portion of the implant body 76 is positioned above the gingival surface 40.

Once the implant body 76 is securely implanted in the jaw bone 34 of the subject, a healing cap (not shown) is placed over the exposed head portion 92 of the implant body. Examples of healing caps are known in the art and can include, for example, those illustrated in U.S. Patent Pub. Nos. 2002/0110784 A1 and 2006/0263747 A1. Placement of the healing cap over the head portion 92 allows the gingival tissue to heal in a natural shape, and prevents both gingival tissue and bone from growing over the head portion of the implant body 76.

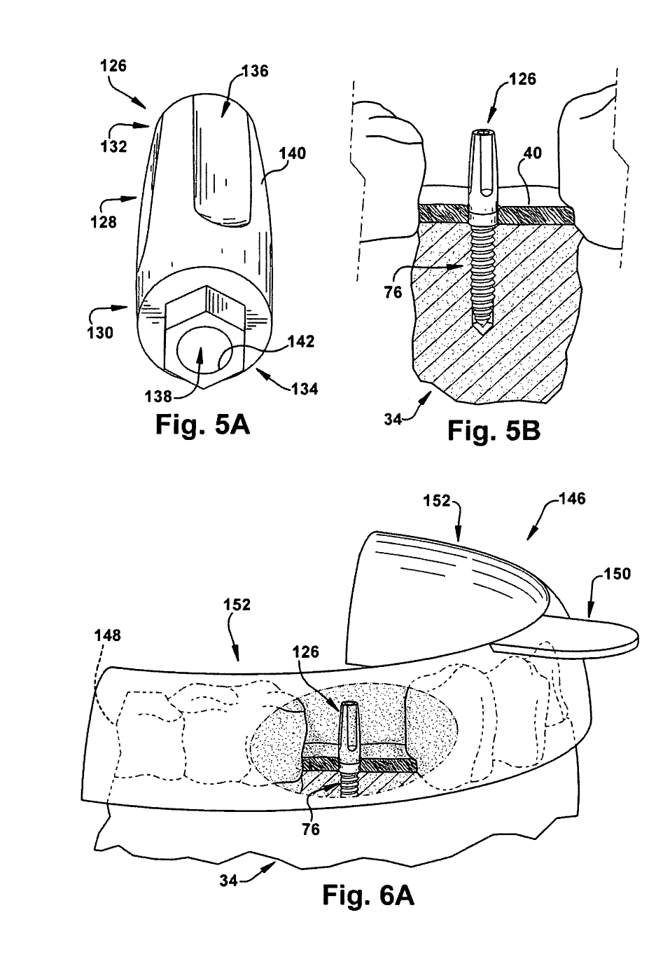

After implanting the implant body 76 in the jaw bone 34 of the subject, an impression coping 126 (FIG. 5A) is mated with the polygonal recess 94 of the implant body 76 at 16. As shown in FIG. 5A, the impression coping 126 comprises a body member 128 having a first end portion 130 and a second end portion 132. The first end portion 130 includes a polygonal-shaped member 134 integrally formed with the second end portion 132. In FIG. 5A, the polygonal-shaped member 134 is hex-shaped; however, it will be appreciated that the polygonal-shaped member can have any variety of other shapes. The second end portion 132 has a tapered configuration and includes a plurality of longitudinal grooves 136. The body member 128 also includes a channel 138 defined by outer and inner surfaces 140 and 142 that extends between the first and second end portions 130 and 132. As shown in FIG. 5B, the polygonal-shaped member 134 of the impression coping 126 is friction fit with the polygonal recess 94 of the implant body 76.

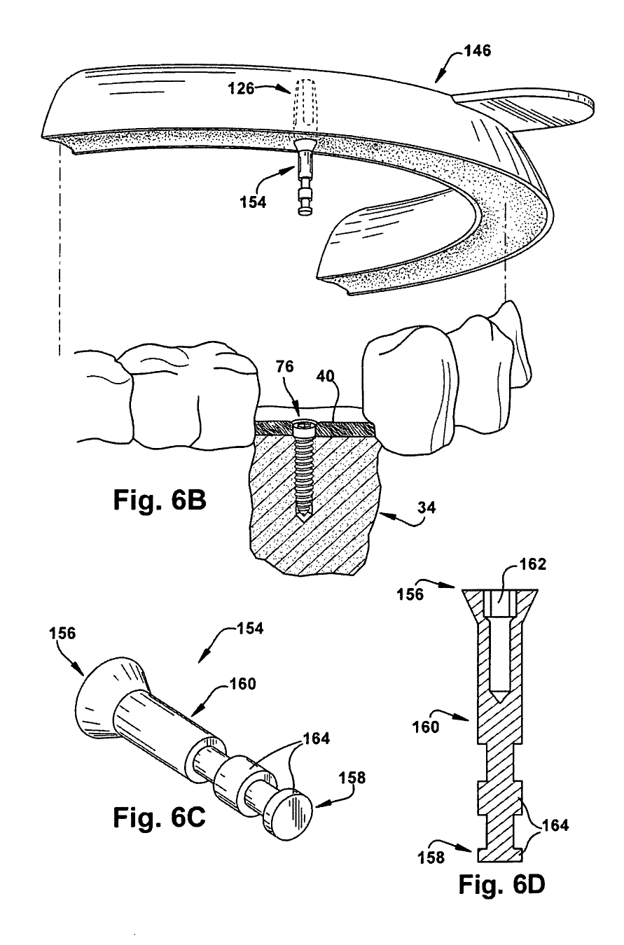

Once the impression coping 126 is securely mated with the implant body 76, an impression of the impression coping is formed at 18. To form the impression, an impression tray 146 (FIG. 6A) is first provided. As shown in FIG. 6A, the impression tray 146 comprises a trough 148 in the form of an arch with a linear central portion 150 integrally formed with two lateral branches 152 that essentially match the form of a dental arch. Impression trays are well known in the art and include, for example, those illustrated in U.S. Patent Pub. Nos. 2005/0244783 A1 and 2005/0153256 A1, and U.S. Pat. Nos. 6,318,997 and 6,017,217.

At 18, the trough 148 of the impression tray 146 can be filled with an impression material (indicated by the dotted pattern). Any one or combination of impression materials can be used. Impression materials are well known in the art and can include, for example, alginate compositions, polyvinyl siloxanes (e.g., HONIGUM, PERFECTIM), and polyethers. After filling the trough 148 with an appropriate amount of impression material, the impression tray 146 is applied to the jaw bone 34 of the subject so that the impression coping 126 is embedded in the impression material (FIG. 6A). Next, the impression tray 146 is removed from the jaw bone 34, bringing along the impression coping 126 which is still embedded in the impression material. The impression material now has the inverse form of the jaw bone 34 along with the impression coping 126 at the site of the dental implant 30.

At 20, an implant analog 154 (FIGS. 6C-D) is mated with the polygonal-shaped member 134 of the impression coping 126 without having to dissect a portion of the impression tray 146 (FIG. 6B). As shown in FIGS. 6C-D, the implant analog 154 comprises a first end portion 156, a second end portion 158, and a main body portion 160 extending between the end portions. The first end portion 156 has a flared configuration and includes a polygonal recess 162 for receiving the polygonal-shaped member 134 of the impression coping 126. The main body portion 160 has a cylindrical shape, and is integrally formed with the first and second end portions 156 and 158. The second end portion 158 includes two bulged sections 164 to facilitate implantation into a cast molding 166 (FIG. 7A).

The fact that the impression tray 146 is not dissected at 20 is advantageous over the prior art methods of forming dental implants. The prior art teaches open and closed-tray approaches to forming dental implants. In a closed-tray approach, an impression coping will remain in a subject's mouth when the impression material is removed, thereby pulling the coping out of the socket formed around it in the impression material. In an open-tray approach, an impression coping will remain within the impression material when the material is removed from the subject's mouth. In either approach, a portion of an impression tray must be cut to access the impression coping. By using a non-open tray approach, the present invention decreases both the time and effort needed to form dental implants.

The present invention is additionally distinguishable from closed-tray methods of the prior art for at least one other reason. Closed-tray methods used in the prior art use an impression cap filled with an impression material to take a negative impression of an impression coping. Use of the impression cap is effective to make a negative impression of the impression coping surface; however, the impression cap does not permit a negative impression of the gingival surface immediately surrounding the impression coping. Unlike the closed-tray methods of the prior art, the present invention (at 18) permits a negative impression to be made of the entire impression coping 126 as well as the gingival surface 40 immediately surrounding the impression coping. This, in turn, facilitates formation of a more natural and better fitting dental implant than the dental implants created by closed-tray methods of the prior art.

At 22, the implant analog 154 is used to form the dental implant 30. A molding material is poured into an inverse form of the subject's jaw bone 34 (made out of the impression material) and allowed to harden (FIG. 7A). Next, the impression tray 146 is removed from the hardened cast molding 166 so that the implant analog 154 is secured in the molding (FIG. 7B). The molding material forms a true or non-inverse model of the jaw bone 34, with the implant analog 154 replicating the implant body 76.

With the implant analog 154 securely fixed in the cast molding 166, a permanent abutment 155 (FIG. 7C) is secured to the implant analog by snap fitting a portion of the permanent abutment into the polygonal recess 162 of the implant analog. After securing the permanent abutment 155 to the implant analog 154, the dental implant 30 or final restoration (FIG. 7C) is formed. The final restoration 30 is formed based on the non-inverse model of the subject's jaw bone 34. For example, the final restoration 30 can be placed over the permanent abutment 155 and then secured to the permanent abutment using an abutment screw (not shown). The final restoration 30 can then be shaped so that the final restoration accurately mimics the subject's natural teeth. After the final restoration 30 is properly situated, the final restoration is detached from the non-inverse model and transferred to the mouth of the subject where it is securely attached to the implant body 76 (FIG. 7C).

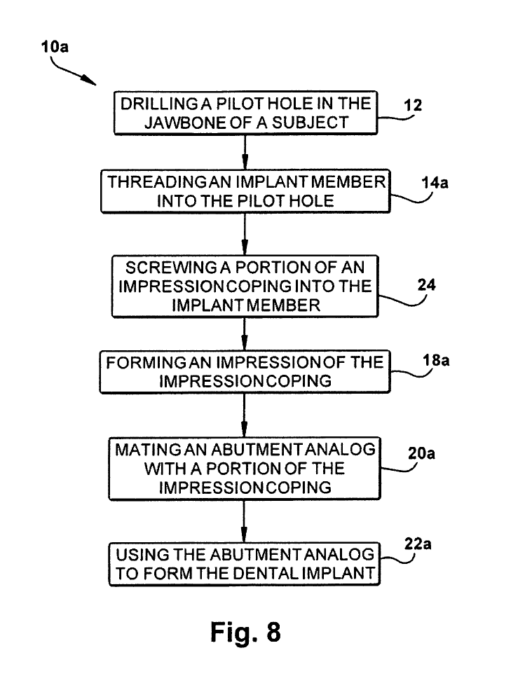

Another aspect of the present invention is illustrated in FIG. 8. The method 10^{a}illustrated in FIG. 8 is identical to the method 10 illustrated in FIG. 1, except as described below. In FIG. 8, steps that are identical as steps in FIG. 1 use the same reference numbers, whereas steps that are similar but not identical carry the suffix “a”.

As shown in FIG. 8, a method 10ₐ for forming a dental implant 30 is provided. One step of the method 10ₐ can include drilling a pilot hole 32 in the jaw bone 34 of a subject at 12. Prior to drilling the pilot hole 32, the dimensions of a surgical site 36 can be measured as described above. Next, the pilot hole 32 can be drilled in the jaw bone 34 using a pilot drill bit 66 and a dental drill (not shown), as described above. After drilling the pilot hole 32, a guide pin 78 can be used to assess the geometry of the pilot hole (as described above).

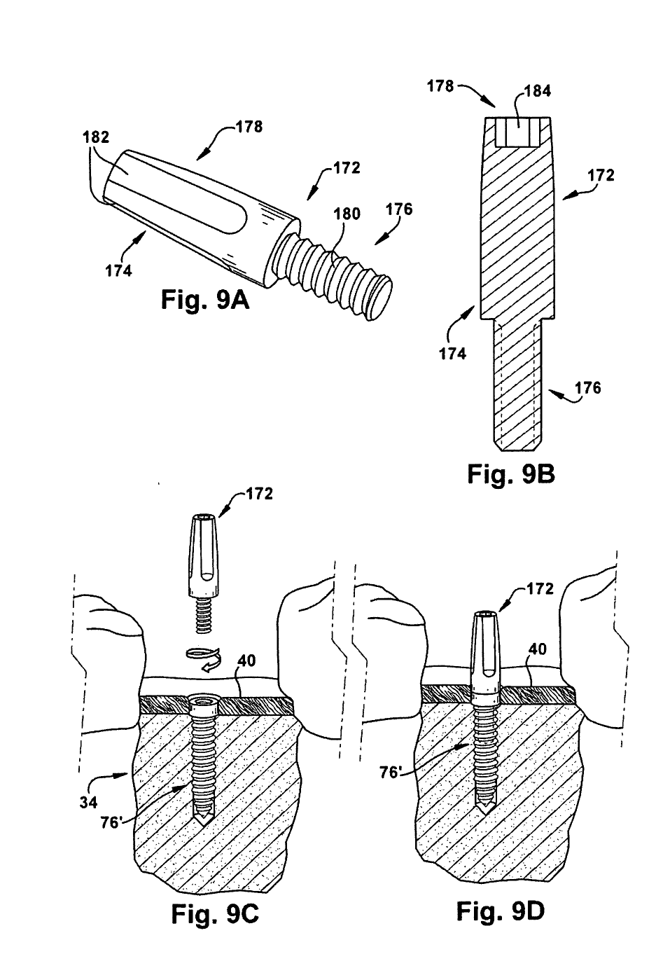

At 14ₐ, an implant body 76′ can be threaded into the pilot hole 32. The implant body 76′ can be identically or similarly constructed as the implant body 76 described above. As shown in FIG. 9C, for example, the implant body 76′ can comprise a body member 88′ having an outer threaded portion 90′ and inner receptacle portion 168. The body member 88′ can be integrally formed with a head portion 92 having a rounded recess 170. The threaded portion 90′ can also include a plurality of spaced-apart threads 96. The threads 96 can be spaced apart at a substantially equal distance and have a rounded configuration. The rounded configuration of the threads 96 can facilitate implantation and osteointegration of the implant body 76′.

Using a torque abutment 86 and a torque tool 84 similar or identical to those described above, the implant body 76′ can be threaded into the pilot hole 32. After the implant body 76′ is securely implanted in the jaw bone 34, a healing cap (not shown) can be placed over the exposed head portion 92 of the implant body. The healing cap can be placed over the head portion 92 to promote healing of the gingival tissue into a natural shape and prevent the gingival tissue and bone from growing over the head portion.

Once the gingival tissue has sufficiently healed, the tissue cap can be removed from the head portion 92. After removing the healing cap, an impression coping 172 (FIGS. 9A-B) can be screwed into the implant body 76′ at 24. As shown in FIGS. 9A-B, the impression coping 172 can comprise a body member 174 having a first end portion 176 and a second end portion 178. The first end portion 176 can include a threaded portion 180 integrally formed with the second end portion 178. The second end portion 178 can have a tapered configuration and include a plurality of longitudinal grooves 182. The second end portion 178 can also include a polygonal-shaped recess 184. In FIGS. 9A-B, the polygonal-shaped recess 184 can be hex-shaped: however, it will be appreciated that the polygonal-shaped recess can have other shapes as well.

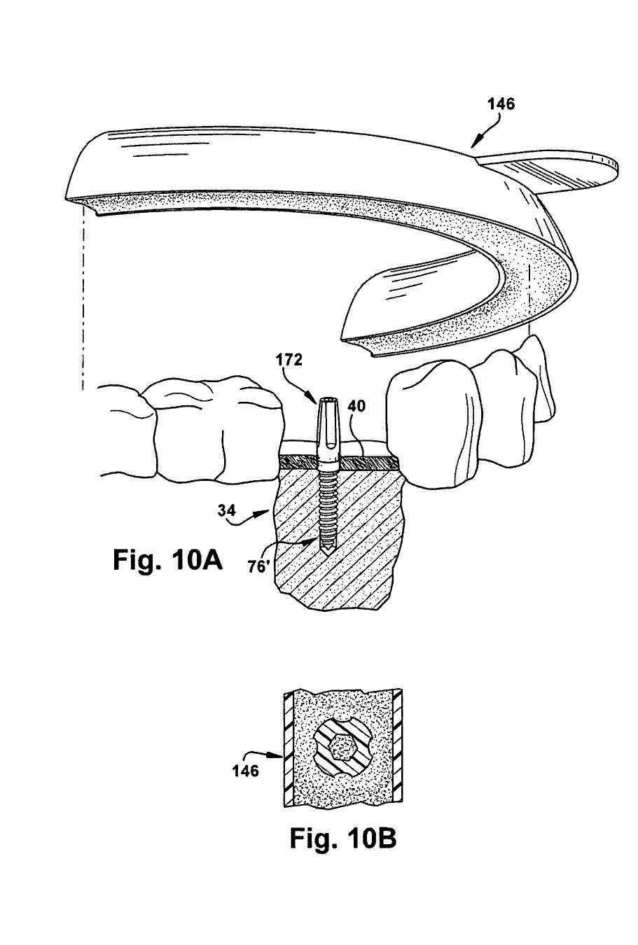

After the impression coping 172 is securely seated on the head portion 92 of the implant body 76′ (FIG. 9D), an impression of the impression coping can be formed at 18₈. As shown in FIG. 10A, an impression tray 146 containing an impression material can be applied to the jaw bone 34 so that the impression coping 172 is embedded in the impression material (as described above). The impression tray 146 can then be lifted from the jaw bone 34, in turn leaving the impression coping 172 securely mated with the implant body 76′. When the impression tray 146 is lifted from the jaw bone 34, an inverse impression of the impression coping 172 may be left in the impression material (FIG. 10B).

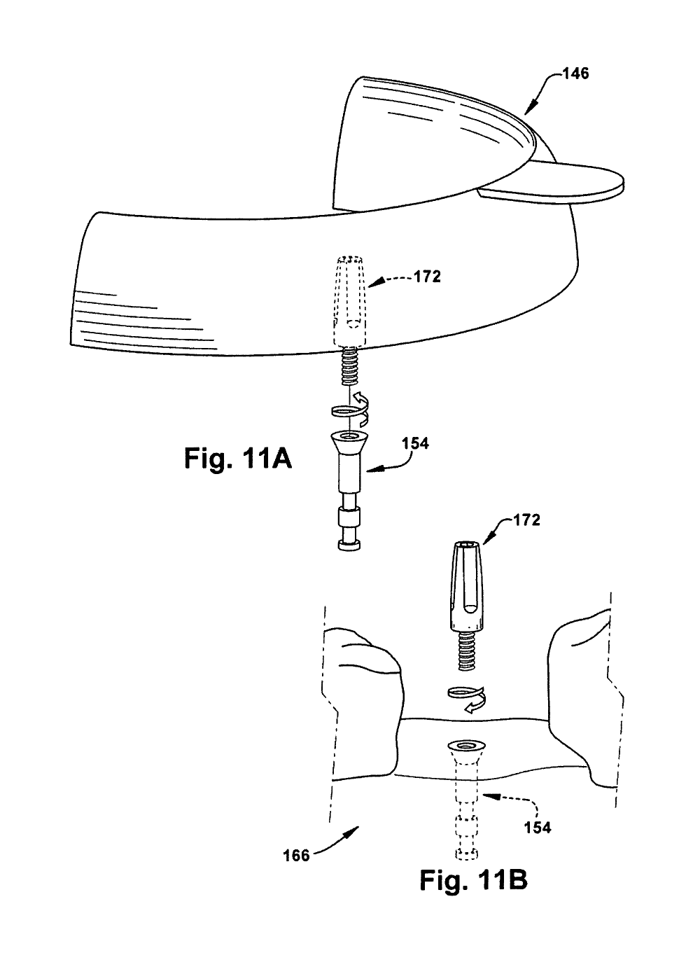

Once the inverse impression has been formed, the impression coping 172 can be unscrewed from the implant body 76′ and inserted into the inverse impression. At 20ₐ, an implant analog 154 can then be mated with the impression coping 172 without dissection a portion of the impression tray 146. The implant analog 154 can be similarly or identically constructed as the implant analog described above. As shown in FIG. 11A, the implant analog 154 can be mated with the threaded portion 180 of the impression coping 172 at 22ₐ. After the implant analog 154 is securely attached to the impression coping 172, the implant analog (along with the impression tray 146 and the impression coping) can be used to form a non-inverse model of the subject's jaw bone 34 (as described above).

The fact that the impression tray 146 is not dissected at 20ₐ is advantageous over the prior art methods of forming dental implants. The prior art teaches open and closed-tray approaches to forming dental implants. In a closed-tray approach, an impression coping will remain in a subject's mouth when the impression material is removed, thereby pulling the coping out of the socket formed around it in the impression material. In an open-tray approach, an impression coping will remain within the impression material when the material is removed from the subject's mouth. In either approach, a portion of an impression tray must be cut to access the impression coping. By using a non-open tray approach, the present invention decreases both the time and effort needed to form dental implants.

Once the non-inverse model is formed, the impression coping 172 can be unscrewed from the implant analog 154 as shown in FIG. 11B. Next, a dental implant 30 or final restoration can be formed (as described above). For example, the final restoration 30 can be mated with the permanent abutment 155 and then shaped so that the final restoration accurately mimics the subject's natural teeth. After the final restoration 30 is properly situated, the final restoration can be detached from the non-inverse model and then transferred to the mouth of the subject where it can be securely attached to the implant body 76′.

From the above description of the invention, those skilled in the art will perceive improvements, changes and modifications. It will be appreciated that separate steps of the present invention can be performed by separate dental practitioners. For example, an implant body 76 can be securely implanted within the jaw bone 34 of a subject by an oral surgeon. The subject can then be seen by a general dentist to complete the method 10 of the present invention and provide the subject with a dental implant 30. Such improvements, changes, and modifications are within the skill of the art and are intended to be covered by the appended claims.

Having described the invention, I claim:

1. A method for forming a dental implant, said method comprising the steps of:
drilling a pilot hole in the jaw bone of a subject;
threading an implant body into the pilot hole, the implant body comprising a threaded portion integrally formed with a head portion having a polygonal recess, the implant body being threaded until the threaded portion reaches a predetermined seating depth;
mating an impression coping with the polygonal recess of the implant body so that a portion of the impression coping is friction fit within the polygonal recess;
forming an impression of the impression coping;
mating an implant analog with a portion of the impression coping without having to dissect a portion of the impression tray; and
using the implant analog to form the dental implant.

2. The method of claim 1, wherein said step of mating an implant analog with a portion of the impression coping further includes forming a negative impression of both the impression coping and the gingival surface surrounding the impression coping.

3. The method of claim 1, said step of drilling a pilot hole in a jaw bone of a subject further comprising the steps of:
puncturing a gingival surface; and
exposing the jaw bone.

4. The method of claim 3, said step of puncturing a gingival surface further comprising the step of applying a tissue punch to the gingival surface so that the tissue punch punctures the gingival surface and contacts the jaw bone.

5. The method of claim 3, said step of exposing the jaw bone further comprising the step of removing a plug of gingival tissue from the tissue punch so that a portion of the jaw bone is exposed.

6. The method of claim 3 further comprising the steps of:
drilling the pilot hole to the predetermined seating depth; and
inserting a guide pin into the pilot hole to assess the geometry of the pilot hole.

7. The method of claim 1, said step of threading an implant body into the pilot hole further comprising the step of securing a healing cap to the head portion of the implant body.

8. The method of claim 1, wherein said step of mating an impression coping the polygonal recess of the implant body further comprises the steps of:
providing an impression coping comprising a body member having first and second end portions, the first end portion including a polygonal-shaped member integrally formed with the second end portion, the second end portion having a tapered configuration and including a plurality of longitudinal grooves, the body member including a channel defined by outer and inner surfaces extending between the first and second end portions; and
mating the polygonal-shaped member of the impression coping with the polygonal recess of the implant body so that the polygonal-shaped member of the impression coping is friction fit within the polygonal recess.

9. The method of claim 1, wherein said step of forming an impression of the impression coping further comprising the steps of:
contacting an impression material with a portion of the impression coping, the impression material being disposed in an impression tray; and
removing the impression tray so that the impression coping is disconnected from the implant body and embedded in the impression material.

10. The method of claim 1, wherein said step of using an implant analog to form the dental implant further comprising the steps of:
contacting the implant analog with a cast material to form a final abutment cavity;
removing the implant analog from the cast material; and
placing a final abutment into the final abutment cavity to form the dental implant.

11. A method for forming a dental implant, said method comprising the steps of:
drilling a pilot hole into the jaw bone of a subject;
threading an implant body into the pilot hole, the implant body comprising a main body portion integrally formed with a head portion, the main body portion including an outer threaded portion and an inner receptacle portion, the implant body being threaded until the threaded portion reaches a predetermined seating depth;
screwing a portion of an impression coping into the inner receptacle portion of the implant body;
forming an impression of the impression coping;
mating an implant analog with a portion of the impression coping without having to dissect a portion of the impression tray; and
using the implant analog to form the dental implant.

12. The method of claim 11, wherein said step of mating an implant analog with a portion of the impression coping further includes forming a negative impression of both the impression coping and the gingival surface surrounding the impression coping.

13. The method of claim 11, said step of drilling a pilot hole in the jaw bone of a subject further comprising the steps of:
puncturing a gingival surface; and
exposing the jaw bone.

14. The method of claim 13, said step of puncturing a gingival surface further comprising the step of applying a tissue punch to the gingival surface so that the tissue punch punctures the gingival surface and contacts the jaw bone.

15. The method of claim 13, said step of exposing the jaw bone further comprising the step of removing a plug of gingival tissue from the tissue punch so that a portion of the jaw bone is exposed.

16. The method of claim 13 further comprising the steps of:
drilling the pilot hole to the predetermined seating depth; and
inserting a guide pin into the pilot hole to assess the geometry of the pilot hole.

17. The method of claim 11, said step of threading an implant body into the pilot hole further comprising the step of securing a healing cap to the head portion of the implant body.

18. The method of claim 11, wherein said step of screwing a portion of an impression coping into the inner receptacle portion of the implant body further comprises the steps of:
providing an impression coping comprising a body member having a first end portion and a tapered second end portion, the first end portion including a threaded portion integrally formed with the second end portion, the second end portion including a plurality of longitudinal grooves and a polygonal-shaped recess; and
screwing the threaded portion into the inner receptacle portion of the implant body.

19. The method of claim 11, wherein said step of forming an impression of the impression coping further comprises the steps of:
removing the impression tray so that a reciprocal impression of the impression coping is made in the impression material;
unscrewing the impression coping from the implant body; and
inserting the impression coping into the reciprocal impression.

20. The method of claim 11, said step of using an implant analog to form the dental implant further comprising the steps of:
contacting an impression material with a portion of the impression coping, the impression material being disposed in an impression tray;
contacting the implant analog with a cast material to form a final abutment cavity;
removing the implant analog from the cast material; and
placing a final abutment into the final abutment cavity to form the dental implant.

21. A method for forming a dental implant, said method comprising the steps of:
mating an impression coping to an implant body secured within the jaw bone of a subject, the implant body comprising a threaded portion integrally formed with a head portion having a polygonal recess, the impression coping being mated to the implant body so that a portion of the impression coping is friction fit within the polygonal recess;
forming an impression of the impression coping;
mating an implant analog with a portion of the impression coping without having to dissect a portion of the impression tray; and
using the implant analog to form the dental implant.

22. The method of claim 21, wherein said step of mating an implant analog with a portion of the impression coping further includes forming a negative impression of both the impression coping and the gingival surface surrounding the impression coping.

23. The method of claim 21, wherein said step of mating an impression coping the polygonal recess of the implant body further comprises the steps of:
providing an impression coping comprising a body member having first and second end portions, the first end portion including a polygonal-shaped member integrally formed with the second end portion, the second end portion having a tapered configuration and including a plurality of longitudinal grooves, the body member including a channel defined by outer and inner surfaces extending between the first and second end portions; and
mating the polygonal-shaped member of the impression coping with the polygonal recess of the implant body so that the polygonal-shaped member of the impression coping is friction fit within the polygonal recess.

24. The method of claim 21, wherein said step of forming an impression of the impression coping further comprising the steps of:
contacting an impression material with a portion of the impression coping, the impression material being disposed in an impression tray; and
removing the impression tray so that the impression coping is disconnected from the implant body and embedded in the impression material.

25. The method of claim 21, wherein said step of using an implant analog to form the dental implant further comprising the steps of:
contacting the implant analog with a cast material to form a final abutment cavity;
removing the implant analog from the cast material; and
placing a final abutment into the final abutment cavity to form the dental implant.

26. A method for forming a dental implant, said method comprising the steps of:
screwing a portion of an impression coping into an inner receptacle portion of an implant body secured within the jaw bone of a subject, the implant body comprising a main body portion integrally formed with a head portion, the main body portion including an outer threaded portion and the inner receptacle portion;
forming an impression of the impression coping;
mating an implant analog with a portion of the impression coping without having to dissect a portion of the impression tray; and
using the implant analog to form the dental implant.

27. The method of claim 26, wherein said step of mating an implant analog with a portion of the impression coping further includes forming a negative impression of both the impression coping and the gingival surface surrounding the impression coping.

28. The method of claim 26, wherein said step of screwing a portion of an impression coping into the inner receptacle portion of the implant body further comprises the steps of:
providing an impression coping comprising a body member having a first end portion and a tapered second end portion, the first end portion including a threaded portion integrally formed with the second end portion, the second end portion including a plurality of longitudinal grooves and a polygonal-shaped recess; and
screwing the threaded portion into the inner receptacle portion of the implant body.

29. The method of claim 26, wherein said step of forming an impression of the impression coping further comprises the steps of:
removing the impression tray so that a reciprocal impression of the impression coping is made in the impression material;
unscrewing the impression coping from the implant body; and
inserting the impression coping into the reciprocal impression.

30. The method of claim 26, said step of using an implant analog to form the dental implant further comprising the steps of:
contacting an impression material with a portion of the impression coping, the impression material being disposed in an impression tray;
contacting the implant analog with a cast material to form a final abutment cavity;
removing the implant analog from the cast material; and
placing a final abutment into the final abutment cavity to form the dental implant.
